(19) United States
(12) Patent Application Publication
(10) Pub. No.: US 2008/0193609 A1
(43) Pub. Date: Aug. 14, 2008

(54) Manufacturing Process and End Product of Vacuum Packed Silage

(76) Inventor: Luiz Sergio Prestes Marcondes, Parana (BR)

Correspondence Address: FURR LAW FIRM, 2622 DEBOLT ROAD, UTICA, OH, 43080, US

(21) Appl. No.: 11/915,850

(22) PCT Filed: May 30, 2006
(86) PCT No.: PCT/BR2006/000106

§ 371 Date: Nov. 29, 2007

(30) Foreign Application Priority Data
Jun. 1, 2005 (BR) PI05027691

(51) Int. Cl. A23L 1/212; B65B 31/02; B65B 1/04

(52) U.S. Cl. 426/106; 426/615; 53/432; 53/469

(57) ABSTRACT

“MANUFACTURING PROCESS AND END PRODUCT OF VACUUM PACKED SILAGE”, described as a manufacturing process and end product of vacuum packed silage which, according to the characteristics thereof, provides, by means of a proprietary and specific industrialized process, the manufacturing of an end product fully based on vacuum packed silage (A), that is, vacuum packing chopped green forage (B) to feed animals, with the purpose of providing a fully mechanized and optimized manufacturing process, and a silage of high nutritional and hygienic quality and, mainly, high durability, and having as a basis a proprietary and specific manufacturing process incorporating an assembly of successive and properly integrated operations formed by a harvesting and chopping phase of the green forage, a packing and weighting phase, a pressing phase, a vacuum phase and a storage phase.

The present patent relates to agricultural processes and products in general, more specifically to a manufacturing process and end product of vacuum packed silage which, according to the general characteristics thereof, possesses as a basic principle to provide, by means of a proprietary and specific industrialized process, the manufacturing of an end product fully based on vacuum packed silages, that is, vacuum packing green forage to feed animals in general, with the purpose of providing a fully mechanized and optimized manufacturing process, and a silage of high nutritional and hygienic quality and, mainly, high durability, and having as a basis a packed silage of great durability, versatility and nutritious capacity. With a specific process for a better adaptation and safety for the users, practical handling and functionality, accessible cost and due to its general characteristics and dimensions, is easily adaptable to the most varied types of green forage or similar items, users and places in general, regardless of the characteristics thereof.

The patent in question is characterized in that it aggregates components and processes in a differentiated concept to meet the several requirements the nature of its use demands, that is, the attainment of a vacuum packed silage with high durability, that is, an extended application interval. Such concept provides a manufacturing process and an end product having great efficiency, functionality, strength, durability, versatility, accuracy and nutritional capacity due to its excellent technical qualities, thereby providing advantages and improvements to the transportation and storage of silages in general, the general characteristics of which differ from the other shapes and models of silages known in the current state of the art.

The present patent consists in the utilization of a modern, efficient, safe and functional manufacturing process and end product of vacuum packed silage formed by an assembly of properly incorporated agricultural, mechanical and physico-chemical solutions comprising a complete differentiated end product of vacuum packed silage of high durability and excellent finish qualities which, due to its proper characteristics, is achieved by means of a proper and specific manufacturing process incorporating an assembly of successive and properly integrated operations formed by a harvesting and chopping phase of the green forage in the fields as a preparation thereof, a packing and weighting phase, a pressing phase to arrange the green forage, a bag vacuum phase to remove air from the bag and a storage phase to allow the green forage to ferment, so as to provide the formation of a unique, complete and safe assembly, whose shapes and internal and external arrangements provide the vacuum packing of several types of green forage, with the specific purpose of providing the application of silages irrespective of the storage and transportation conditions that may be found.

Cattle, be that dairy cattle or beef cattle, need high quality food throughout the year. Weather conditions in most regions, however, does not allow for green pastures during every month of the year. Result: in the rainy season, pastures abound; in the dry season, they are in shortage; in wintertime, they are completely destroyed by the snow and frost; in many regions, the cattle starve to death. And that in normal conditions, when no droughts, rainfalls or extended winters occur or even during the attack of plagues or diseases, which worsens the situation even more. Throughout the centuries, though, countries with advanced agriculture have learned how to overcome such problems, mainly due to the development of methods of preserving green material for cattle feed during pasture shortage months, being the ensilage process the most important one among those methods, an extremely simple, economical, and practical way—therefore, within the range of any cattle breeder—of storing forage for a long period of time, provided special conditions are kept, and preserving almost of all of the properties of its nutrients and comprising the entire silage production process, which includes forage plantation, and its subsequent harvesting, fragmentation, transport, silo loading, compacting, sealing and use of the ready product.

Silage is the product of the fermentation process of green forage in special conditions, for a certain period of time, provided it is completely protected from air, being this factor—absence of air—the most important requirement to achieve proper results in the production of silage and the durability thereof. Silage preserves the properties of forage for several months in the absence of oxygen, during which it is used as food for the cattle, mainly dairy cows. This way, silage is a way of making the cost of production cheaper, thus saving in rations and other types of cattle food. The practice of ensilage has been shown to be highly feasible, for besides providing plenty of food for the cattle throughout the year, irrespective of the weather conditions, the cattle farmer yields greater productivity in milk and beef when supplying animals with silage associated with other foods.

During the ensilage process, forage remains alive after harvesting, that is, its cells use oxygen and feed themselves from the reserves found in the plant tissues; the plants, along with the soil and the atmosphere, contain several microorganisms (bacteria, fungi, etc.) that can develop in favorable conditions, like moisture, proper temperature and the absence of air. After harvesting, chopping and loading forage in the silo, bacterial action starts and, as the silo must be loaded by eliminating as much oxygen as possible from the mass and fully excluding air and water seepage, the residual oxygen is consumed by the plant cells that help start the bacteria anaerobic (free of oxygen) reaction, that is, the fermentation of forage, a process which is concluded after a thirty-day cycle, upon reaching stability. At such specific conditions, the silage will keep for an indefinite period of time providing it does not enter in contact with air and water, thus keeping its properties, taste and smell favored by the cattle; otherwise, it must be quickly consumed.

Thus, the main inconvenient of the shapes and models of silages known in the current state of the art is the storage and transportation thereof, due mainly to the high degree of spoilage and extremely low durability; current processes allow silages to be marketed for a maximum period of twenty four hours in the presence of air; beyond that, they spoil.

In view of those inconveniences, the general concept of the manufacturing process and end product of vacuum packed silage is based on packing the forage in a bag immediately after its harvesting, so as to undergo the anaerobic fermentation process and, consequently, originate the silage end product, that is to say, the fermentation of vacuum packed green forage occurs directly inside the bag over a 20 to 30 day period. After that time, silage is ready to be directly consumed by the animals, and provided it is kept inside the bag, it can be stored for the same period of time as a conventional silage, that is, more than one year; as long as the bag is sealed, there is no oxygen contact and, therefore, no product spoilage. Thus, marketing of silage, currently restricted due to its sudden deterioration, is hugely facilitated, because packed silage can be transported and stored for longer periods and in several different quantities, being suitable for animal consumption for a long period of time, to be used in the proper time and amount required.

The objects, advantages and other characteristics of the patent in question can be more easily understood when read jointly with the appended drawings, wherein:

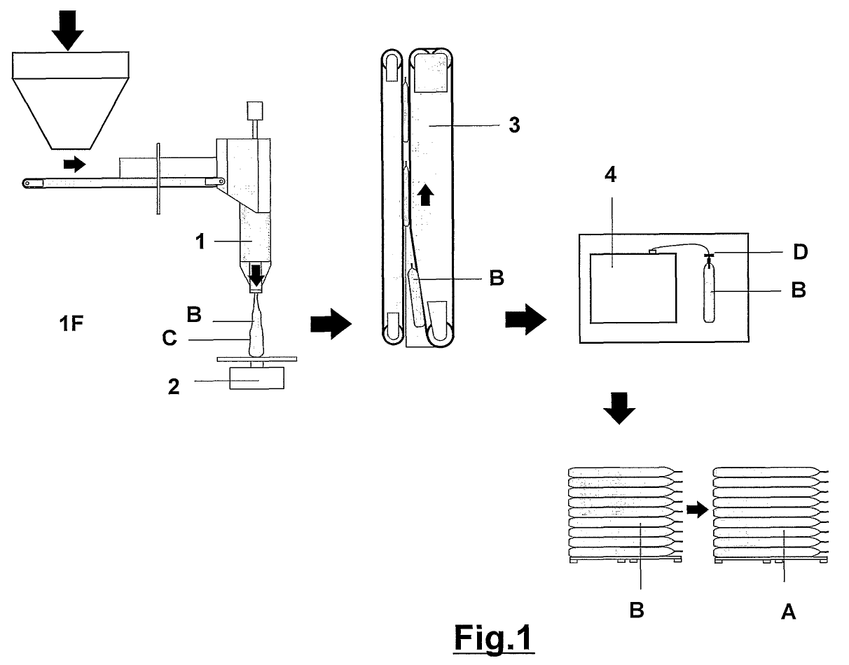

FIG. 1 is a schematic view of the manufacturing process and end product of vacuum-packed silage.

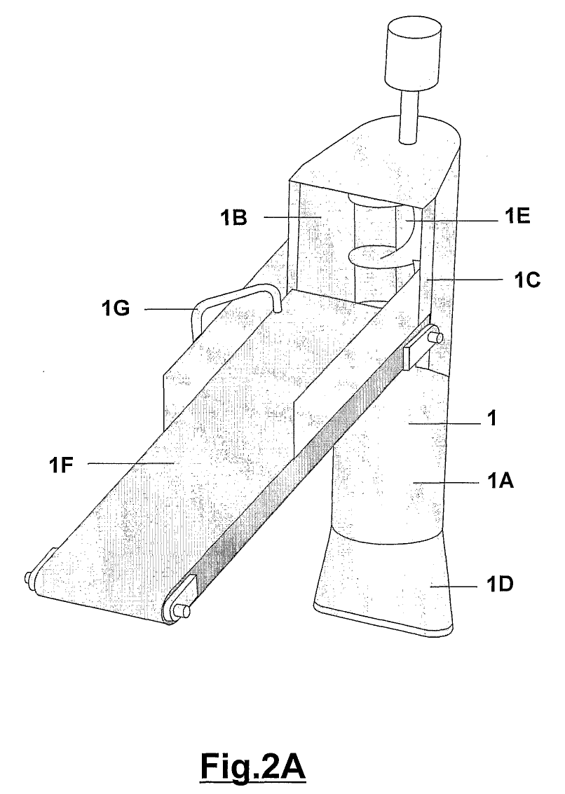

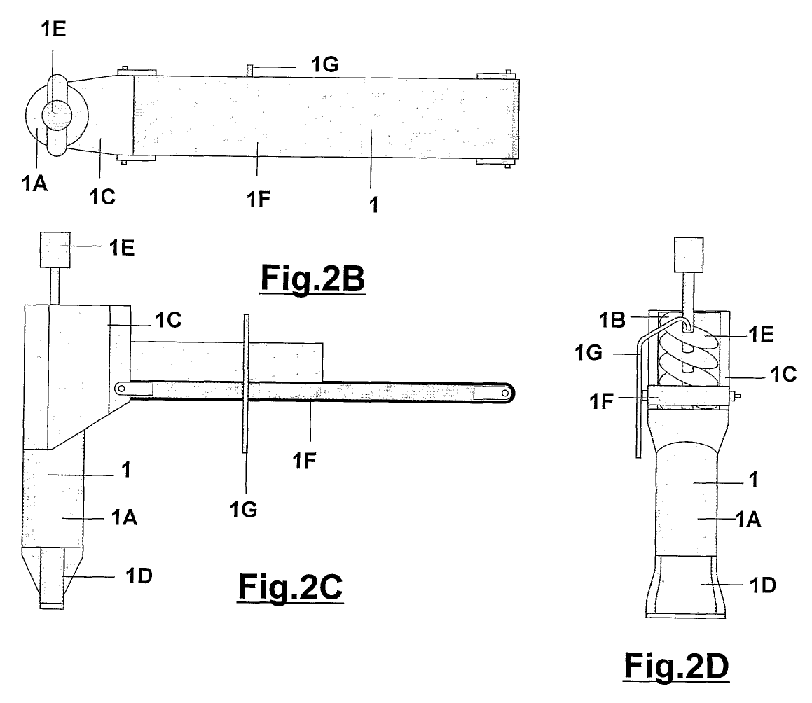

FIG. 2A is a perspective view of the bag filling machine in the configuration with a thread applied in the manufacturing process and end product of vacuum packed silage.

FIG. 2B is an upper view of the bag filling machine in the configuration with a thread applied in the manufacturing process and end product of vacuum packed silage.

FIG. 2C is a side plan view of the bag filling machine in the configuration with a thread applied in the manufacturing process and end product of vacuum packed silage.

FIG. 2D is a front view of the bag filling machine in the configuration with a thread applied in the manufacturing process and end product of vacuum packed silage.

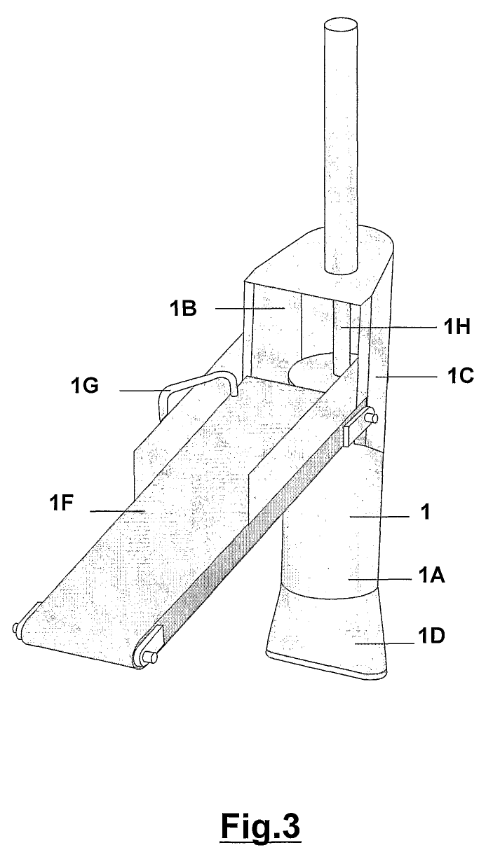

FIG. 3 is a perspective view of the bag filling machine in the configuration with a piston applied in the manufacturing process and end product of vacuum packed silage.

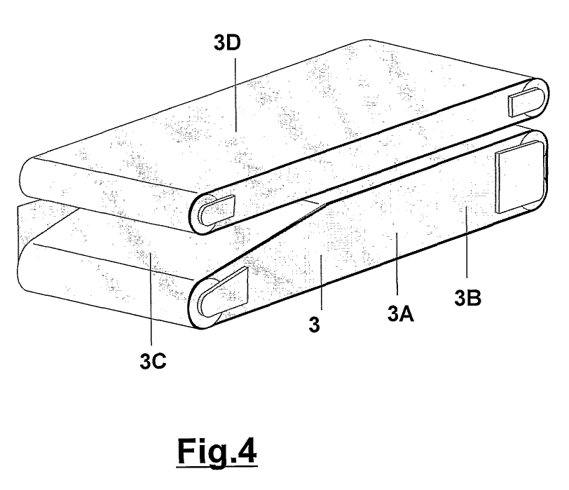

FIG. 4 is a perspective view of the conveyor belt press applied in the manufacturing process and end product of vacuum-packed silage.

As can be inferred from the appended drawings that illustrate and integrate the present descriptive report of the patent of invention of “Manufacturing Process and End Product of Vacuum Packed Silage”, FIG. (1) shows the same in a general manner, comprising a complete end product of vacuum packed silage (A) with proprietary characteristics incorporating a proper and specific structure of the pressed and vacuum bagged type, of high durability and excellent end qualities, fully free of air, having a general shape similar to that of the bag and filled with the most varied types of chopped green forage (B), the vacuum packed silage (A) being achieved by a proprietary and specific process incorporating an assembly of successive and properly integrated operations formed by a harvesting and chopping phase of the green forage directly in the fields in a manual or mechanized way, so as to produce a chopped green forage mass (B); a packing and weighting phase of the chopped green forage (B) carried out in a bag filling machine (1) and scales (2), for compactly loading the chopped green forage (B) inside bags (C) using the bag filling machine (1) according to the weight supported by the bag (C) using the scales (2); a pressing phase of the chopped green forage mass (B) and bags (C) carried out in a conveyor belt press (3), for the proper loading of the chopped green forage mass (B) together with the almost full exclusion of air inside the bags (C); immediately after the pressing phase, a clamp (D) is symmetrically arranged along the periphery of the bag top opening (C) to fully close it; a vacuum phase of the chopped green forage mass (B) and bags (C) carried out in a vacuum pump (4), to pack the chopped green forage mass (B) inside bags (C) with the absence of air inside it, and immediately after the vacuum process, the clamp is removed (D) and a seal is applied symmetrically along the periphery of the bag top opening (C) to fully seal it; and a storage phase of the chopped green forage mass (B) and bags (C) for storage and fermentation thereof for over a 20 to 30 day period and, consequently, producing the end product, the vacuum packed silage (A) ready to use and with a durability of more than a year.

The bag filling machine (1), as shown from FIGS. (2A) to (2D), comprises a structure having a general shape similar to an inclined “T” possessing a central body (1A) of general cylindrical hollow shape vertically and symmetrically arranged and having a front opening (1B) of general rectangular shape vertically and symmetrically centered on the frontal face, a front flap (1C) having a general trapezoidal shape vertically, symmetrically and frontally aligned with the front opening (1B), a bottom mouth (1D) having a general shape similar to a funnel with an oblong lower end vertically and symmetrically centered in the lower end and an inner thread (1E) having a general spiral shape vertically and symmetrically centered along the periphery of the inner side, the entire assembly performing the main function of compactly loading the chopped green forage (B) inside bags (C); a front conveyor belt (1F) having a general parallelepipedal shape horizontally and symmetrically aligned with the front opening (1B) and the front flap (1C), with the main function of guiding the chopped green forage mass (B) to inside the central body (1A); an additive device (1G) having a general tubular shape vertically and symmetrically arranged over the front conveyor belt (1F) and close to the front flap (1C), performing the main function of adding additives to the chopped green forage mass (B) before compacting and packing; and an electric motor symmetrically arranged close to the central body (1A), performing the main function of driving the inner thread (1E) and the front conveyor belt (1F).

The bag filling machine (1), as shown on FIG. (3), can be comprised by an inner piston (1H) having a general cylindrical shape vertically and symmetrically centered along the periphery of the central body inner side (1A) instead of the inner thread (1E), performing the main function of compactly loading the chopped green forage mass (B).

The conveyor belt press (3), as shown on FIG. (4), comprises a central structure (3A) having a general parallelepipedal shape and a lower conveyor belt (3B) having a general trapezoidal shape horizontally and symmetrically arranged along the periphery of the lower side, the chamfer (3C) being symmetrically arranged on its front end; an upper conveyor belt (3D) having a general parallelepipedal shape horizontally, paralellaly and symmetrically arranged along the periphery of the upper side and the lower conveyor belt (3B); and an electric motor performing the basic function of driving the lower and upper conveyor belts (3B) and (3D); the chopped green forage mass (B) and bags (C) crosses the central structure center (3A), that is, symmetrically between the lower and upper conveyor belts (3B) and (3D).

For all of the above, this is a process that will be well received by cattle breeders in general, since the present manufacturing process and end product of vacuum packed silage presents several advantages, such as: great safety, reliability and agility in its application; great productivity and performance due to its general concept; great strength and durability, and lower or no wear of the assembly as a whole; greater comfort, facility and safety for the users in general; practical and safe usage by any users anywhere; a perfect and direct adaptation to several types of chopped green forage (B); fully accessible costs which provides an optimum cost/benefit ratio; low weight and general dimensions; great mobility and flexibility allowing an easy transportation; large range of application; very low cost and practical maintenance; and the certainty of always having a product that fully meets the required conditions for its application such as productivity and hygiene.

For all of the above, the manufacturing process and end product of vacuum packed silage can be classified as a fully efficient, safe, accurate and complete means for vacuum packing the most varied types of chopped green forage (B), so as to obtain, after the fermentation process inside the bag (C), the most varied types of vacuum packed silages (A) with high durability and versatility, for several farmers and/or cattle breeders in several different places, regardless of the general characteristics thereof, they are also easy to apply and to handle, and have excellent general characteristics; the sizes and dimensions may vary, depending on the use needs.

1.) “MANUFACTURING PROCESS AND END PRODUCT OF VACUUM PACKED SILAGE”, characterized in that it comprises a complete end product of vacuum packed silage (A) provided with proprietary characteristics and incorporating a proper and specific structure of the vacuum pressed and bagged type, of high durability and fully free of air, having a general shape similar to that of the bag and filled with the most varied types of chopped green forage (B).

2.) “MANUFACTURING PROCESS AND END PRODUCT OF VACUUM PACKED SILAGE”, in accordance with claim 1, characterized in that it comprises a proprietary and specific process of vacuum packed silage (A) incorporating an assembly of successive and properly integrated operations formed by a harvesting and chopping phase of the green forage in the fields in a manual or mechanized way, so as to produce a chopped green forage mass (B), a packing and weighting phase of the chopped green forage (B) carried out in a filling bag machine (1) and scales (2), to compactly load the chopped green forage mass (B) inside bags (C) using the filling bag machine (1) according to the weight supported by the bag (C) using the scales (2); a pressing phase of the chopped green forage mass (B) and bags C) carried out in a conveyor belt press (3), to compactly load the chopped green forage mass (B) inside bags (C) along with the almost full exclusion of air, and immediately after the pressing phase a clamp is symmetrically arranged (D) along the periphery of the bag top opening (C), to fully close it; a vacuum phase of the chopped green forage mass (B) and bags (C) carried out in a vacuum pump (4), to pack the chopped green forage mass (B) inside bags (C) with the absence of air inside it; immediately after the vacuum process, the clamp is removed (D) and a seal is applied symmetrically along the periphery of the bag top opening (C), to fully seal it; and a storage phase of the chopped green forage mass (B) and bags (C) for storage and fermentation thereof for over a 20 to 30 day period and, consequently, producing the end product, the vacuum packed silage (A).

3.) “MANUFACTURING PROCESS AND END PRODUCT OF VACUUM PACKED SILAGE”, in accordance with claim 2, characterized in that the bag filling machine (1) comprises a structure having a general shape similar to an inclined “T” possessing a central body (1A) of general cylindrical hollow shape vertically and symmetrically arranged and possessing a front opening (1B) having a general rectangular shape vertically and symmetrically centered on the front face, a front flap (1C) having a general trapezoidal shape vertically, symmetrically and frontally aligned with the front opening (1B), a bottom mouth (1D) having a general shape similar to a funnel with an oblong lower end vertically and symmetrically centered in the lower end and an inner thread (1E) having a general spiral shape vertically and symmetrically centered along the periphery of the inner side; a front conveyor belt (1F) having a general parallelepipedal shape horizontally and symmetrically aligned with the front opening (1B) and the front flap (1C); an additive device (1G) having a general tubular shape vertically and symmetrically arranged over the front conveyor belt (1F) and close to the front flap (1C); and an electric motor symmetrically arranged close to the central body (1A).

4.) “MANUFACTURING PROCESS AND END PRODUCT OF VACUUM PACKED SILAGE”, in accordance with claims 2 and 3, characterized in that the filling bag machine (1) comprises an inner piston (1H) having a general cylindrical shape vertically and symmetrically centered along the periphery of the central body inner side (1A) instead of the inner thread (1E).

5.) “MANUFACTURING PROCESS AND END PRODUCT OF VACUUM PACKED SILAGE”, in accordance with claim 2, characterized in that the conveyor belt press (3) comprises a central structure (3A) having a general parallelepipedal shape possessing a lower conveyor belt (3B) of general trapezoidal shape horizontally and symmetrically arranged along the periphery of the inner side, the chamfer (3C) being symmetrically arranged in the frontal end; an upper conveyor belt (3D) having a general parallelepipedal shape horizontally, paralellaly and symmetrically arranged along the periphery of the upper side and lower conveyor belt (3B); and an electric motor performing the main function of driving the lower and upper conveyor belts (3B) and (3D).
